(19) United States
(12) Patent Application Publication
(10) Pub. No.: US 2025/0005631 A1
(43) Pub. Date: Jan. 2, 2025

(54) DELIVERING FRESH AND/OR ENGAGING CONTENT TO WEB SITES AND THEIR ADVERTISEMENTS USING ARTIFICIAL INTELLIGENCE

(71) Applicants: MICHAEL ONGHAI, PHOENIX, AZ (US); Lawrence David Herman, New York, NY (US)

(72) Inventors: MICHAEL ONGHAI, PHOENIX, AZ (US); Lawrence David Herman, New York, NY (US)

(21) Appl. No.: 18/217,569

(22) Filed: Jul. 2, 2023

(51) Int. Cl. G06Q 30/0241; G06F 16/951

(52) U.S. Cl. CPC G06Q 30/0277; G06F 16/951

(57) ABSTRACT

In a system for delivering fresh and/or engaging content to a web site, a programming interface may request a generative artificial intelligence program to generate a summary of an advertisement (or an article) or an answer to a query about the advertisement either (i) on-demand or (ii) in anticipation of a later request, and store the summary or answer. Scripting language programming instructions monitors whether a user viewing a web site screen engages the advertisement (or the headline of the article) by taking a predefined action, and (b) when the user engages the advertisement (or the headline) by the predefined action, displays the summary of the advertisement (or of the article) or the answer to the query about the advertisement on the user's device while the web site is still viewed by the user. A web crawler may crawl for the articles on a topic or may crawl the advertisements.

### FIELD OF THE INVENTION

The invention is in the field of using artificial intelligence to deliver additional content, such as fresh and/or engaging content, to web sites and to online advertisements.

### BACKGROUND OF THE INVENTION

Publishers publish an advertisement by an advertiser on the publisher's web site. For example, if a law firm advertises on nytimes.com, when a user likes the advertisement and clicks on it the click takes the user out of the web site of the publisher. While the advertiser is happy and willing to pay the publisher for that outcome, even if the publisher gets paid for that outcome, the publisher loses the user in the sense that the user is no longer on the web site of the publisher and there exists a possibility, even a strong one in some cases, that the user will not return to the publisher's web site.

Similarly, Taboola, an advertising company, provides advertisements in the form of “Around the Web” and “Recommended For You” boxes at the bottom of online news articles. If a user reads an article on a publisher's web site, and Taboola or another advertising company offer the user-typically at the end of the article-other articles that are similar to the article being read, this may occur in the form of a list of titles (the titles being headlines for the content) of the other articles to click on. If the user is attracted to the titles and clicks on one of them the click takes the user out of the web site of the publisher. Again, while the advertiser is happy and willing to pay the publisher (or Taboola) for that outcome, even if the publisher gets paid for that outcome, the publisher loses the user in the sense that the user is no longer on the web site of the publisher. Once again there exists a possibility, even a strong one in some cases, that the user will not return to the publisher's web site.

On the other hand, if the publisher does not allow the advertisement to click through to another web site—that of the advertiser—the advertiser will not consider the advertisement to be as valuable (and not be willing to pay the publisher as much as he otherwise would for the advertisement).

### SUMMARY OF THE EMBODIMENTS

Applicant has discovered that it is possible to effectively encourage users to stay at a web site while still providing fresh engaging content to the web site using information gleaned from other web sites.

One embodiment is a system for delivering fresh engaging content to a web site, comprising: a memory storage; a programming interface configured to send a request to a generative artificial intelligence program to generate a summary of an article either (i) on demand or (ii) in anticipation of a later request, and store the summary on a server of the web site; scripting language programming instructions stored on the memory, that when executed by a processing unit perform: (a) repeatedly checking whether a user viewing a web site screen engages a clickable headline of the article by taking a predefined action, (b) when the user engages the headline by the predefined action, a browser displays the summary of the headline on the client computer while the web site is still viewed by the user.

In some embodiments, the system further comprises a web crawler for crawling the web and searching for and indexing articles relating to a pre-identified topical area including the article.

In some embodiments, the headline, when clicked by the user, takes the user to a different publisher's web site.

In some embodiments, the predefined action comprises the user moving a cursor or a body portion over the headline. In some embodiments, the predefined action comprises the user keeping the cursor or body portion over the headline for a predefined length of time.

In some embodiments, the predefined action comprises the user scrolling to an area on the user's screen (i) that is a predefined distance from the headline or (ii) where the headline is viewable.

In some embodiments, the scripting language programming instructions also, when executed, perform: the browser, when the user engages the headline, opening a chat box on a screen of the user to exchange messages with the user concerning the article underlying the headline without the user having to leave the web site publishing the headline.

In some embodiments, generative artificial intelligence programming instructions configured to, when executed by the processing unit, generate a second summary of content and store the second summary on the server of the web site; and

wherein the scripting language programming instructions also, when executed, perform
(a) repeatedly checking whether the user viewing the web site screen engages a clickable headline that is within the summary of the content by a second predefined action,
(b) when the user engages the clickable or advertisement that is within the summary by the second predefined action, manipulating and populating HTML such that the browser displays the text and any images of the second summary on the client computer while the web site is still viewed by the user.

In some embodiments, the browser displays the summary within a display unit that includes the headline.

Another embodiment is a system for delivering fresh engaging content to a web site, comprising: a programming interface that requests from a generative artificial intelligence program to generate a summary of an advertisement or an answer to a query about the advertisement either (i) on demand or (ii) in anticipation of a later request, and store the summary or answer on a server of the web site; scripting language programming instructions stored on a memory, that when executed by a processing unit perform: (a) repeatedly checking to determine whether a user viewing a web site screen engages the advertisement by taking a predefined action, (b) when the user engages the advertisement by the predefined action, displaying, by a browser, the summary of the advertisement or the answer to the query about the advertisement on the user's device while the web site is still viewed by the user.

In some embodiments, the system further comprises a web crawler for crawling advertisements on one or more web sites to catalog/index information gleaned from the advertisement.

In some embodiments, the advertisement when clicked takes the user to a different publisher's web site.

In some embodiments, the scripting language programming instructions also, when executed, perform: prior to displaying the summary upon engagement by the user of the advertisement, either retrieving the summary from memory or requesting, by the programming interface, of the generative artificial intelligence program to generate the summary.

In some embodiments, the predefined action is the user moving a cursor or a body portion over the advertisement. In some embodiments, the predefined action comprises the user maintaining the cursor or body portion over the advertisement for a predefined length of time.

In some embodiments, the predefined action comprises the user scrolling to an area on the user's screen (i) that is a predefined distance from the advertisement or (ii) where the advertisement is viewable.

In some embodiments, the scripting language programming instructions also, when executed, perform: the browser, when the user engages the advertisement, opening a chat box on a screen of the user to exchange messages with the user concerning the product or service advertised in the advertisement without the user having to leave the web site publishing the advertisement.

In some embodiments, the scripting language programming instructions is configured to have the browser open a chat box on the user's screen, when the user engages the advertisement, and wherein the programming interface is configured to request that the generative artificial intelligence program generate a response to a query of the user concerning a product or services advertised in the advertisement, the response displayed in the chatbox while the web site is being viewed by the user.

A further embodiment is a method of delivering fresh engaging content to a web site, comprising: crawling, using a web crawler, a digital advertisement on an advertiser's web site; requesting, using a programming interface, that a generative artificial intelligence program generates a summary of the advertisement; and executing scripting language programming instructions stored on a memory of a processing unit to: (a) repeatedly check to determine whether a user viewing a publisher's web site where the advertisement is displayed engages the advertisement by taking a predefined action, wherein the advertisement is clickable so as to leave the publisher's web site, (b) when the user engages the advertisement by the predefined action, display, by a browser, the summary of the advertisement in an advertising unit that includes the advertisement and that is displayed while the web site is being viewed by the user.

In some embodiments, the method further comprises requesting the generating of the summary of the advertisement on demand after the user takes the predefined action.

In some embodiments, the method further comprises requesting that the generative artificial intelligence program generates the summary of the advertisement in advance of the user taking the predefined action and storing the summary on a memory storage.

In some embodiments, the method further comprises executing the scripting language programming instructions stored on the memory of the processing unit to repeatedly check whether the user viewing the web site screen moves a cursor or a body portion over the advertisement. In some embodiments, the method further comprises executing the scripting language programming instructions stored on the memory of the processing unit to repeatedly check whether the user keeps the cursor or body portion over the advertisement for a predefined length of time.

In some embodiments, the method further comprises executing the scripting language programming instructions stored on the memory of the processing unit to repeatedly check whether the user scrolls to an area on the user's screen (i) that is a predefined distance from the advertisement or (ii) where the advertisement is viewable.

In some embodiments, the method further comprises executing the scripting language programming instructions to have the browser open a chat box on the user's screen, when the user engages the headline, to exchange messages with the user concerning the product or service promoted in the advertisement without the user having to leave the web site publishing the advertisement.

In some embodiments, the method further comprises requesting, using the programming interface, that the generative artificial intelligence program generate a response to a query concerning a product or services advertised in the advertisement and displaying the response to the query in the chatbox while the web site is being viewed by the user.

Yet another embodiment is a method of delivering fresh engaging content to a web site, comprising: requesting, by a programming software interface, a generative artificial intelligence program to generate a summary of an article and store the summary on a server of the web site; executing scripting language programming instructions stored on the memory of a processing unit to: (a) repeatedly check to determine whether a user viewing a web site screen engages a clickable headline by taking a predefined action, (b) when the user engages the headline by the predefined action, display, by a browser, the summary of the headline on the client computer while the web site is still viewed by the user.

In some embodiments, the method further comprises using a web crawler to search for and index articles relating to a pre-identified topical area, wherein the article is one of the articles found in the search by the web crawler.

In some embodiments, the method further comprises executing the scripting language programming instructions stored on the memory of the processing unit to repeatedly check whether the user viewing the web site screen moves a cursor or a body portion over the headline. In some embodiments, the method further comprises executing the scripting language programming instructions stored on the memory of the processing unit to repeatedly check whether the user keeps the cursor or body portion over the headline for a predefined length of time.

In some embodiments, the method further comprises executing the scripting language programming instructions stored on the memory of the processing unit to repeatedly check whether the user scrolls to an area on the user's screen (i) that is a predefined distance from the headline or (ii) where the headline is viewable.

In some embodiments, the method further comprises executing the scripting language programming instructions to have the browser open a chat box on the user's screen, when the user engages the headline, to exchange messages with the user concerning the article underlying the headline without the user having to leave the web site publishing the headline.

In some embodiments, the method further comprises requesting the generating of the summary of the article on demand after the user takes the predefined action.

In some embodiments, the method further comprises requesting that the generative artificial intelligence program generates the summary of the advertisement in advance of the user taking the predefined action and storing the summary on a memory storage.

In some embodiments, the method further comprises executing generative artificial intelligence programming instructions to generate a second summary of content and to store the second summary on the server of the web site; and executing the scripting language programming instructions to:
(a) repeatedly check to determine whether the user viewing the web site screen engages a clickable headline that is within the summary of the content by taking a second predefined action, and
(b) when the user engages the clickable headline that is within the summary by the second predefined action, the browser displays the text and any images of the second summary on the client computer while the web site is still viewed by the user.

### BRIEF DESCRIPTION OF THE DRAWINGS

Various embodiments are herein described, by way of example only, with reference to the accompanying drawings, wherein:

FIG. 1A is a block diagram of a system that delivers fresh engaging content comprising a summary of an advertisement to a web site, in accordance with one embodiment;

FIG. 1B is a block diagram of a system, including a web crawler, that delivers fresh engaging content comprising a summary of an advertisement to a web site, in accordance with one embodiment;

FIG. 2 is a block diagram of an advertising/advertisement unit, in accordance with one embodiment;

FIG. 3A is a block diagram of a system for delivering fresh engaging content such as summarized articles to users without the user leaving the web site, in accordance with one embodiment;

FIG. 3B is a block diagram of a system including a web crawler for delivering fresh engaging content such as summarized articles to users without the user leaving the web site, in accordance with one embodiment;

FIG. 4 is a flow chart showing a method of delivering fresh engaging content to a web site in the form of summaries of advertisements obtained on-demand, in accordance with one embodiment;

FIG. 5 is a flow chart of another method of delivering fresh engaging content to a web site in the form of summaries of advertisements obtained from a cache, in accordance with one embodiment;

FIG. 6 is a flow chart of a method of delivering fresh engaging content to a web site in the form of article summaries accessed from a cache, in accordance with one embodiment;

FIG. 7 is a flow chart of a method of delivering fresh engaging content to a web site in the form of article summaries obtained on-demand, in accordance with one embodiment;

FIG. 8A is a block diagram of an advertising unit utilizing a chatbot, in accordance with one embodiment; and

FIG. 8B is a block diagram of a content unit utilizing a chatbot, in accordance with one embodiment.

### DETAILED DESCRIPTION OF THE EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain embodiments generally provide a system and method of delivering fresh engaging content to web sites and to their advertisements. If a web site is of the kind that presents content in a particular topical area, for example a web site that has a database of case law for research or a medical database, a user may be viewing a legal article or a medical article on the web site. Often, legal cases cite other legal cases in the form of a title or headline of the case. Similarly, medical articles often cite other medical articles in the form of a title or headline of the new medical article. Furthermore, Taboola presents articles similar to the article being read by the user. In any of these scenarios if the user is interested in and clicks on the headline of the new article, a system allows the user to learn about the new legal or medical article without leaving the web site of the publisher. This provides fresh engaging content to the original web site. The topical fields of “legal” and “medical” are merely examples of predefined topic areas.

In one embodiment, a system for delivering fresh engaging content to a web site, may comprise a web crawler for crawling the web and searching for and indexing content relating to a pre-identified topical area, and may comprise a processing unit including a memory, a generative artificial intelligence programming instructions configured to, when executed by the processing unit, generate a summary of the content and store the summary on a computer memory for example on a server of the web site, and may include scripting language programming instructions stored on the memory, that when executed by the processing unit perform:
(a) repeatedly checking whether a user viewing a web site screen engages a clickable headline by taking a predefined action,
(b) when the user engages the headline by the predefined action, manipulating and populating HTML such that a browser displays the text and any images of the summary of the headline on the client computer while the web site is still viewed by the user.

In addition, a user may be viewing any web site that publishes advertisements and may see an advertisement for a product or service. If the user likes the advertisement and clicks on it the system allows the user to remain on the web site of the publisher yet still learn more about the product or service. This delivers fresh engaging content to the publisher's webs site and may be satisfactory to the advertiser.

One embodiment is a system for delivering fresh engaging content to a web site. The system may include a processing unit and may include a memory. The system may also include:
a programming interface that requests from a generative artificial intelligence program to generate a summary of an advertisement or an answer to a query about the advertisement either (i) on demand or (ii) in anticipation of a later request, and may store the summary or answer for example on a server of the web site;
scripting language programming instructions stored on the memory, that when executed by the processing unit perform:
(a) repeatedly checking to determine whether a user viewing a web site screen engages the advertisement by taking a predefined action, wherein the advertisement may be a clickable advertisement for a product or service,
(b) when the user engages the advertisement by the predefined action, having a browser display the summary of the advertisement on the client computer while the web site is still viewed by the user.

The system may optionally also include a web crawler for crawling the web site for the advertisements of the advertiser.

In one implementation, a chatbot is utilized to prompt a user to make a query about a product or service advertised in the advertisement (or about an article).

The principles and operation of Delivering Fresh and/or Engaging Content to Web Sites and Their Advertisements Using Artificial Intelligence may be better understood with reference to the drawings and the accompanying description.

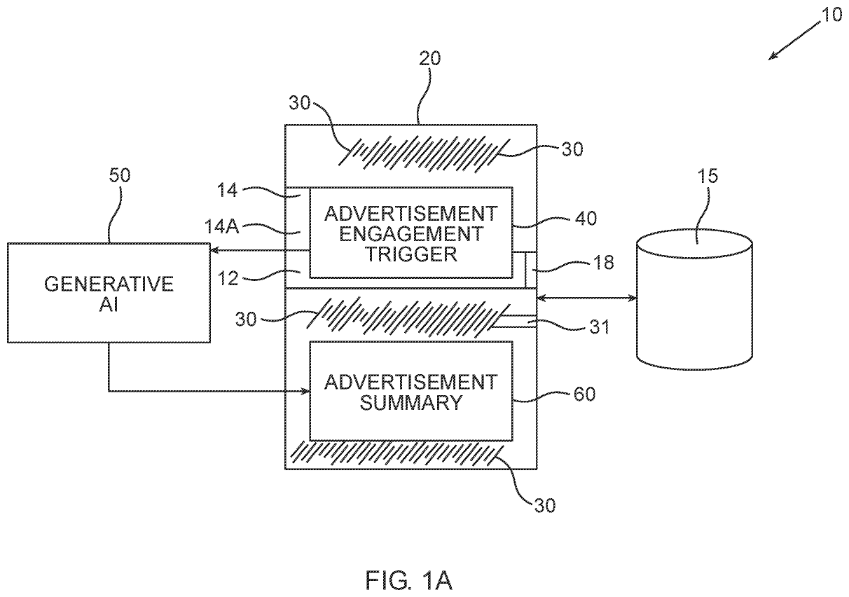

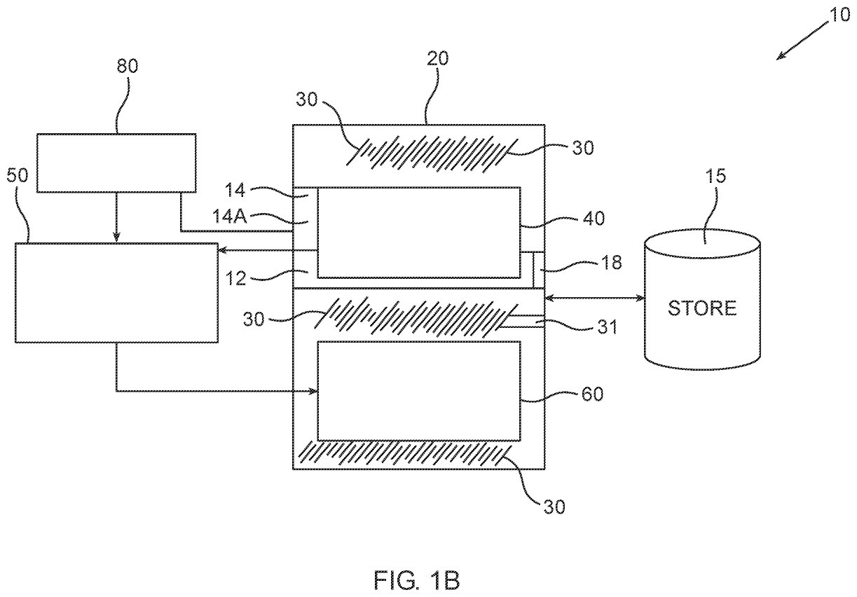

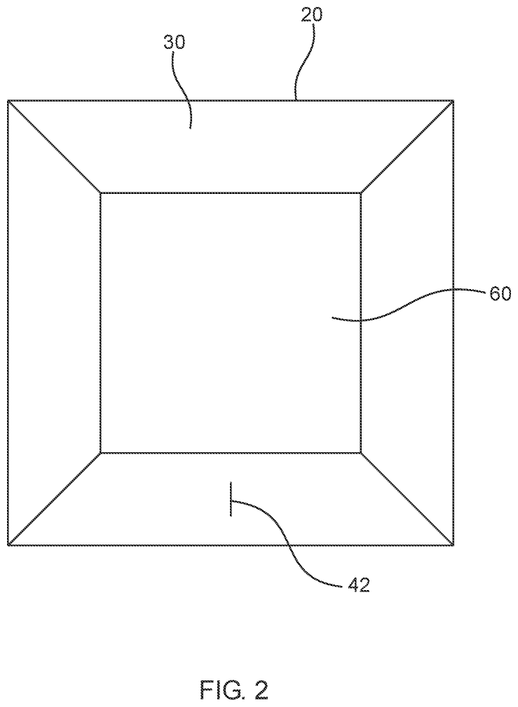

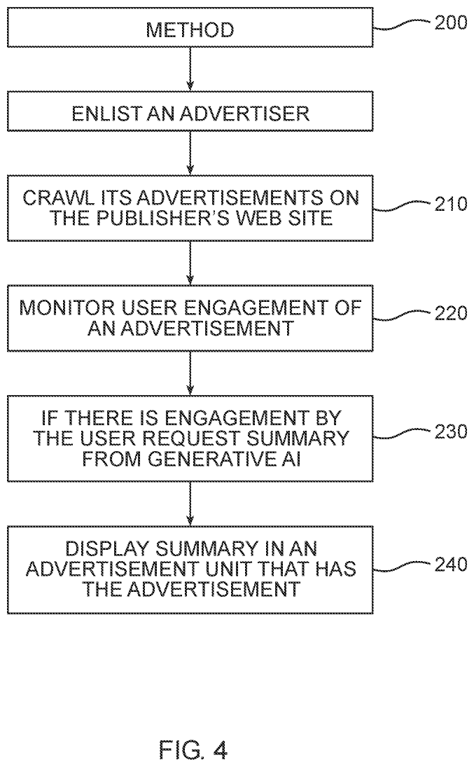

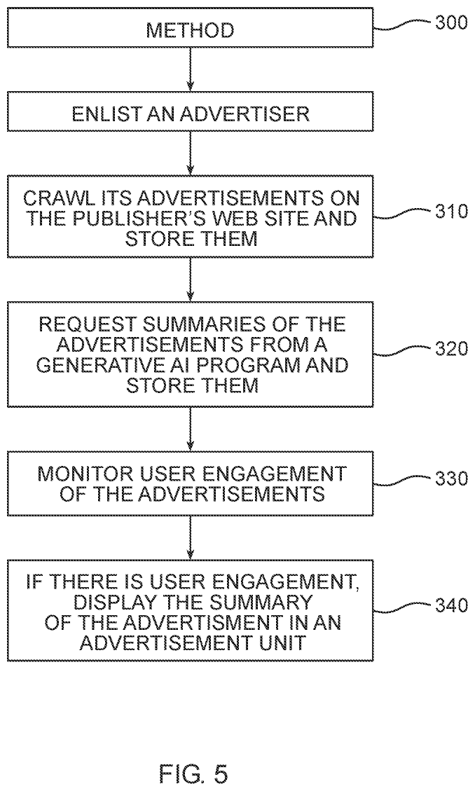

In accordance with one embodiment shown in FIG. 1A, FIG. 1B, FIG. 2, FIG. 4, FIG. 5, a system 10 for delivering additional content, for example fresh engaging content, to a web site, which may be a web site that publishes advertisements 30, may include a processing unit 12 including a memory 15 and programming instructions 14. The programming instructions 14 may include a programming interface 14A, for example software, that is configured to send requests to a generative artificial intelligence program 50 (which may be external to system 10) to generate a summary 60 of a particular advertisement 30. One non-limiting example of a generative AI program 50 is ChatGPT™.

In any embodiment herein, memory 15, 115 may include one or more non-transitory computer readable (storage) medium(s) having computer readable program code embodied thereon. In any embodiment herein, programming instructions 14, 114 may include code, software, firmware, resident software, micro-code etc. In any embodiment herein, processing unit 12, 112 may include programming instructions 14, 114 stored on memory 15, 115 and executed by one or more processors of processing unit 12, 112.

The programming instructions 14 of system 10 may be configured or may also be configured to send a request to the generative AI program 50 to generate an answer 65 to a query, for example a specific query by a user, about the specific advertisement 30 that the user is viewing. The specific query may concern a product 31 or service 31 advertised in the advertisement 30.

With respect to these requests to the generative AI program 50 to generate a summary 60 of the advertisement 30, system 10 may be configured in one of two ways: either (i) to initiate such a request on-demand when there already is a need because for example the user has already engaged the advertisement 30 or (ii) to initiate such a request in advance of and/or in anticipation of when the user has engaged the advertisement 30. In the second configuration, system 10 would then store the summary 60 of the advertisement 30 in for example one or more memory storage entities 15 such as a cache 15. The memory storage 15 or memory storage entities 15 may be situated in any accessible location, and this includes on a server computer of the web site.

Even in the case of a request of the generative AI program 50 to generate an answer 65 to the user's query, there could be two different configurations. Accordingly, with respect to such requests to the generative AI program 50 to generate an answer to the user's query for example concerning a product or service advertised in the advertisement 30, system 10 may be configured either (i) to make the request on-demand after the user has engaged the advertisement 30 and has sent a query about the product or service 31 advertised or (ii) to make the request in anticipation of such user query by using generative artificial intelligence program 50 (or a different AI program) or a human-generated list of likely user queries. In this second configuration, system 10 would then store the answers to the likely queries in the one or more memory storage entities 15 such as a cache 15. An AI program or a human may anticipate the queries of the user by generating queries that are in common with most products and services advertised. For example: “what is the price of the product advertised in the advertisement?” is one non-limiting example of such a predictable user query. Another non-limiting example is be “what are the shipping options for your product?”.

System 10 may also comprise scripting language programming instructions 18 stored on the one or more memory 15. One non-limiting example of such scripting language programming instructions is Javascript®. In some embodiments, the scripting language (SL) programming instructions, when executed by the processing unit 112, perform:
(a) checking, for example repeatedly checking, to determine whether a user viewing a web site screen engages the advertisement 30 by taking a predefined action, and
(b) when the user engages the advertisement 30 by the predefined action, displaying, for example by a browser, the summary of the advertisement or the answer to the user's query concerning a product or service advertised in the advertisement 30.

Upon engagement by the user of the advertisement, which is detected by advertisement engagement trigger 40, either the summary is retrieved from memory at that point and displayed to the user for example in the advertising unit 20 or else at that point a request is sent by the programming interface 14A to the generative artificial intelligence program 50 to generate the summary 60 of the advertisement based on the information obtained from a web crawler 80 which in this embodiment (FIG. 1A) is external to (and therefore not shown in) system 10 and in the embodiment shown in FIG. 1B is part of system 10. The summary 60 is retrieved and displayed to the user for example as part of an advertising unit 20 that includes the original advertisement 30. In some embodiments, this occurs in real time.

In one implementation the scripting language programming instructions cause the browser to manipulate and populate HTML such that the browser displays the text and any images of the summary of the advertisement or the answer to the user query. In some embodiments, the display is shown to the user on the screen being viewed by the user while the web site is still being viewed by the user. In any event, the display may be shown to the user on the client computer.

The advertisement 30 may be a clickable advertisement for a product or service such that the user would normally be taken to a different web site if the user responded positively to the advertisement. Accordingly, the system 10 delivers fresh engaging content to the publisher's web site while at the same satisfying the business interests of the advertiser whose advertisement is followed-up on for the user. In some embodiments, the advertisement is not clickable.

With regard to the predefined action taken by the user that constitutes “engagement” by the user with the advertisement, sufficient to trigger retrieval and display of the summary (or answer to a query about product or service advertised in the advertisement) or generating and display of the summary (or answer), in some embodiments the predefined action is defined as the user moving a cursor 42 (FIG. 2) or a body portion over the advertisement. The term “body portion” used in any embodiment herein refers to providing input other than by a mouse or other input device. For example, when the device used by the user is a mobile phone, instead of a mouse, the user may slide his or her own thumb, finger or other portion of the user's body along portions of the screen to provide input.

In another embodiment, the predefined action is defined as the user maintaining the cursor or body portion over the advertisement for a predefined length of time, for example X number of seconds (for example 0.5 seconds or 1 second or 2 seconds or 3 seconds or 4 seconds or 5 seconds or another length of time). In another embodiment, calling “scrolling engagement”, the predefined action is defined as the user scrolling to an area on the user's screen (i) that is a predefined distance from the advertisement or (ii) where the advertisement is viewable.

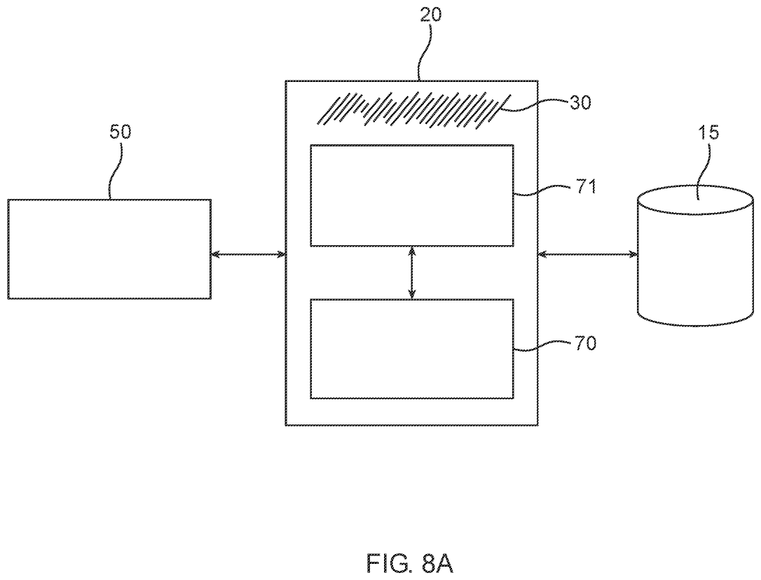

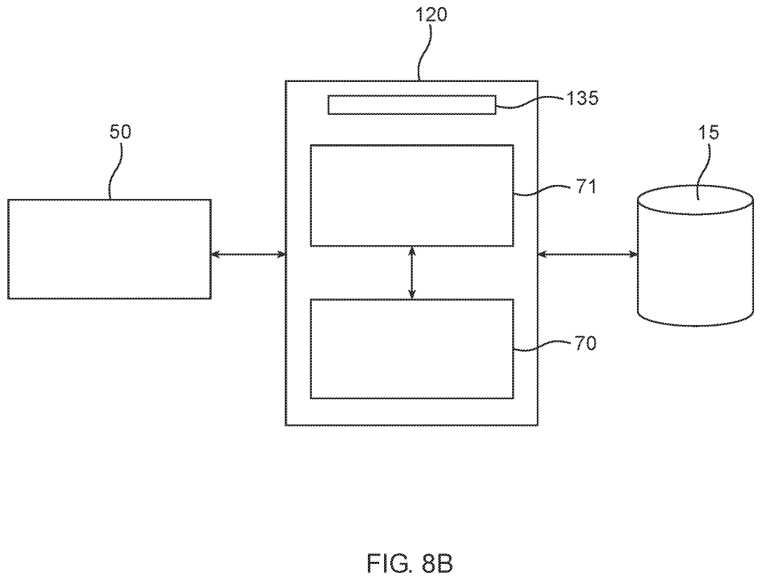

In some embodiments, as seen in FIG. 8A, the scripting language programming instructions 18 also, when executed, performs, having the browser utilize a chat bot 70 to open a chat box 71 on the user's screen when the user engages the advertisement 30. The chat box is configured to allow an exchange of messages with the user concerning the product or service advertised in the advertisement 30 without the user having to leave the web site publishing the advertisement. Although from FIG. 8A it is not clear that the chatbox 71 can be situated within the borders of the advertisement 30 itself, it is the case that in one embodiment at least, a portion of chatbox 71 (or all of it) may be situated in a manner that blocks the view of part of the advertisement 30.

As shown in FIG. 8A, the scripting language programming instructions 18 may be configured to have the browser utilize a chatbot 70 that invites the user to make a query about the advertisement 30. For example, the chat bot 70 may open a chatbox 71 that states “ask me anything about selling your old car”. The chatbot 70 also opens a box for the user to input responsive text constituting a user query such as “I have a Honda civic 1990 how much to sell”. The chatbot displays a reply box that displays the answer to the user query generated by the chatbot 70. This interaction is initiated when the user engages the advertisement 30 in with the predefined action. In some implementations, the system 10 (for example the chatbot 70 or the programming interface 114A) may send a request to the generative AI program 50 to generate the response to a query of the user concerning a product or services advertised in the advertisement 30, the response then being displayed in the chatbox while the web site is being viewed by the user. In some implementations, it may be unnecessary for the system 10 to trigger a request of the generative AI program 50 to create a summary of the advertisement 30 unless the user requests it.

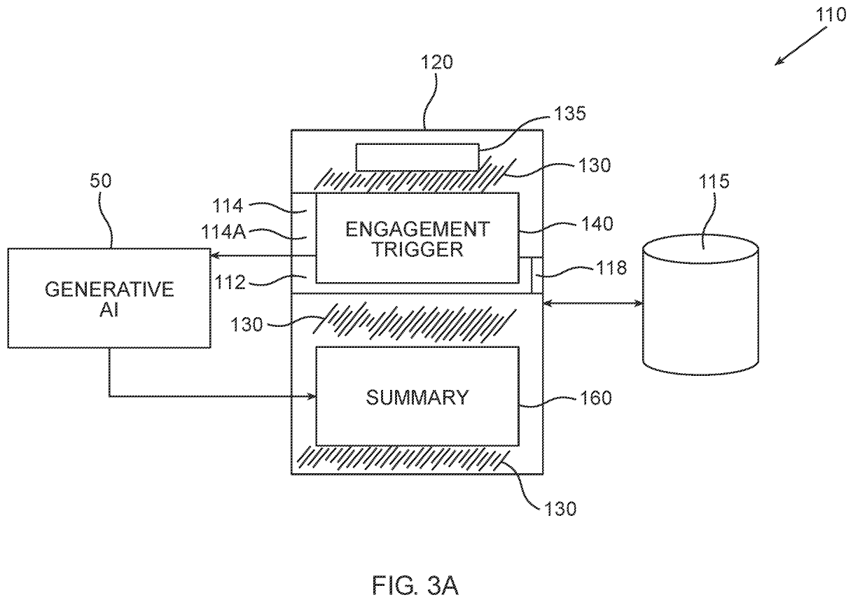

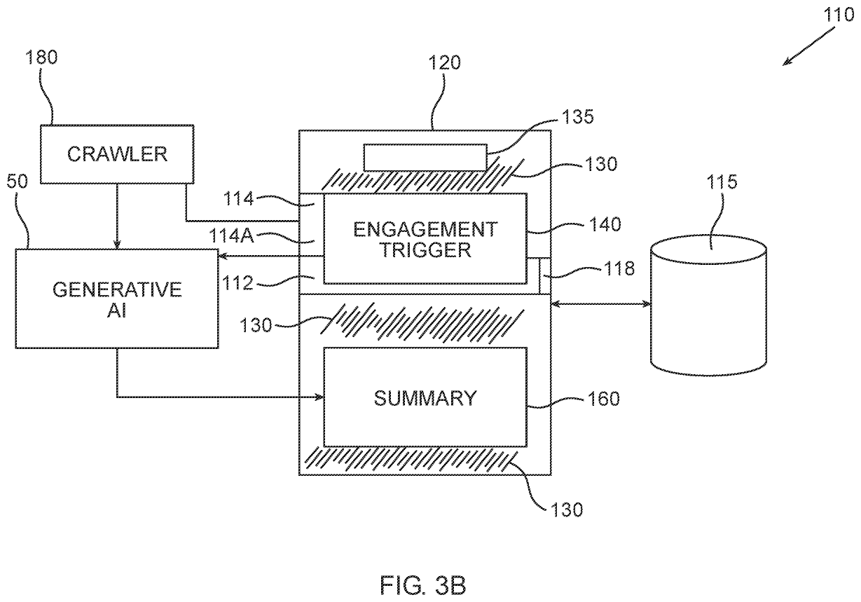

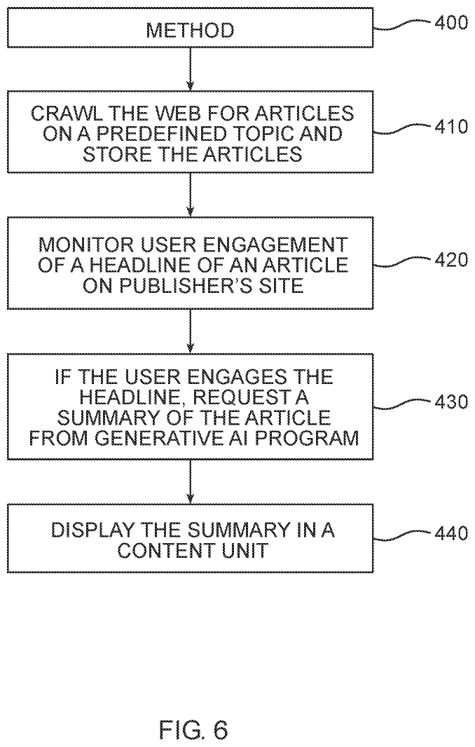

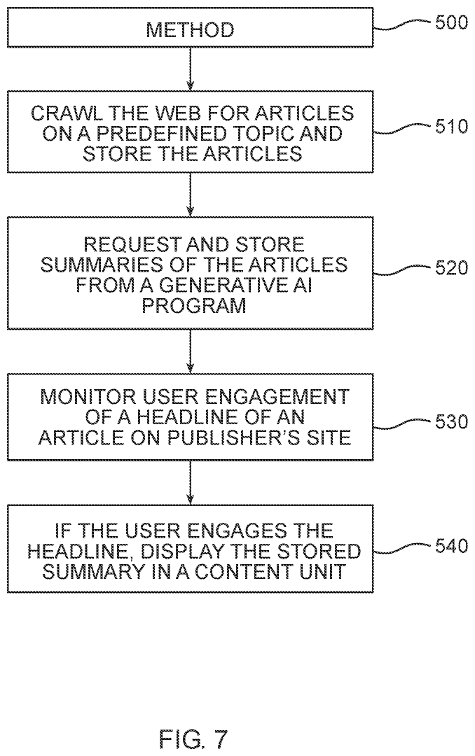

Another embodiment, as shown in FIG. 3A, FIG. 6 and FIG. 7, is a system 110 for delivering additional content, for example fresh engaging content, to a web site, for example a web site that publishes articles on a particular topic. Non-limiting examples of a predefined topic include legal articles or medical articles. The user may be researching a particular topic for example on a medical database or on a legal research database and may be viewing a screen in which a headline 135 for an article in the field being researched. If the headline 135 relates to a legal article, the headline 135 may be in the form of a formal legal citation used in legal research, such as XYZ Corp v. Google LLC, 52 F.4th 1099, 2022 WL 7719644 (Fed. Cir. 2021). Many publishers of a legal articles or medical articles will not have all other legal articles or other medical articles in its database. For example, NYTimes.com web site does not have every legal or medical article. Therefore, if a user is reading a legal article on NYTimes.com and sees a headline 135 of another article in the form of a legal citation, clicking on that headline 135 would result in leaving the NYTimes.com web site. However, using the system 110, it would not be necessary to click on the headline 135 to get information about the underlying article. Rather in some embodiments, engaging the headline 135, as defined herein, would result in triggering the display of a summary 160 of the article that the headline is associated with.

As shown in FIG. 3B, a web crawler 180, which may be software, may optionally be part of system 110. The web crawling software 180 may be configured for crawling web sites to search for and index legal articles medical articles or articles in another predefined topical field. These indexed articles would then be fed to the generative artificial intelligence software 50 to generate a summary 160 of the article which is then stored for example in a storage 15.

System 110 may include a processing unit 112 and may include a memory storage 115 and programming instructions 114. The programming instructions may include a programming interface 114A, for example software, that is configured to send requests to a generative artificial intelligence program 50 (which may be external to system 10) to generate a summary 160 of a particular article. One non-limiting example of a generative AI program 50 is ChatGPT™.

The programming interface 114A of system 110 for delivering fresh engaging content to a web site may be configured to send the request to the generative artificial intelligence program 50 to generate the summary 160 of the article 130 either (i) on demand or (ii) in anticipation of a later request, and store the summary 160 on a server of the web site.

System 110 may include scripting language programming instructions 118 stored in the memory 115, which when executed by the processing unit 112, are configured to perform:
(a) repeatedly checking whether a user viewing content 130 on a web site screen engages a headline 135 of an article (the article itself not shown in FIG. 3A since it is not viewable by the user on the screen) by taking a predefined action,
(b) when the user engages the headline 135 by the predefined action, (in one non-limiting example by manipulating and populating HTML such that) a browser displays the summary 160 of the article on the client computer while the web site is still viewed by the user.

Upon engagement by the user of the headline 135, which is detected by engagement trigger 140, which may comprise programming instructions stored on a memory 15 or a combination of such instructions and hardware, in one mode the article summary 160 is retrieved from memory at that point and displayed to the user for example in a display unit 120 also referred to as a content unit 120. In a second mode, the on-demand configuration, after user engagement is detected a request is first sent by the programming interface 114A to the generative artificial intelligence program 50 to generate the article summary 160, for example in real time, and then the article summary 160 is retrieved and displayed to the user for example in the display unit or content unit 120. The display unit or content unit 120 comprises the content 130 viewed by the user and comprises the summary 160 generated after the user engages the headline 135.

System 110 components not seen by the user include engagement trigger 140, storage 115, processing unit 112 scripting language 118, programming interface 114A.

In one implementation, the scripting language programming instructions 118 cause the browser to manipulate and populate HTML such that the browser displays the summary of the article. In some embodiments, the display is shown to the user on the screen being viewed by the user while the web site is still being viewed by the user. In any event, the display may be shown to the user on the client computer.

The headline 135 may be a clickable headline 135 such that when the user clicks it, the user is taken to the article itself (which article is not otherwise viewable by the user) which would be on a different web site. Accordingly, the system 110 delivers fresh engaging content to the publisher's web site.

With regard to the predefined action taken by the user that constitutes “engagement” by the user with the headline 135, sufficient to trigger retrieval and display of the summary 160 or generating and display of the summary 160 of the headline 135, in some embodiments the predefined action is defined as the user moving a cursor or a body portion over the headline 135. In another embodiment, the predefined action is defined as the user maintaining the cursor or body portion over the headline 135 for a predefined length of time. In another embodiment, namely scrolling engagement, the predefined action is defined as the user scrolling to an area on the user's screen (i) that is a predefined distance from the headline 135 or (ii) where the headline 135 is viewable.

In some embodiments, as seen in FIG. 8B, the scripting language programming instructions 118 is also configured, when executed, to utilize a chatbot 170 to have the browser open a chat box 172 on the user's screen when the user engages the headline 135. The chat box 172 prompts a user to make a query about the article that underlies the headline 135. A box would then open for the user to type the query and a box would open for the chatbot 170 to answer the query. The chatbot 170 requests an answer from the generative AI program 50 by means of the programming interface 114A or by means of the scripting programming language. The chat box 172 is configured to allow an exchange of messages with the user concerning the article summarized by the summary 160 without the user having to leave the web site publishing the advertisement. The response to the user is displayed in the chatbox 172 while the web site is still being viewed by the user.

In this way the user need not leave the publisher's web site even though the user is intrigued by the article or wants to follow up his or her research concerning the topic of the article. It is common when researching professional literature on a topic such as medicine or law, that one wants to jump from an article one is reading to another article cited by that article.

In one particular optional expanded implementation of system 110 (and this applies equally to system 10), the user may view summary 160 and see a secondary headline of another article within the summary 160. In that case, if the user engages the second headline 135 the generative artificial intelligence program 50 may be requested to generate a second summary of content and store the second summary on the server of the web site. Then the scripting language programming instructions 118, when executed, perform (a) repeatedly checking whether the user viewing the web site screen engages a clickable headline that is within the summary of the content by a second predefined action, (defined the same way as the first predefined action or another way described herein) and (b) when the user engages the clickable or advertisement that is within the summary by the second predefined action, having the browser display the second summary, for example on the client computer, while the web site is still viewed by the user. The second summary is the summary of an article mentioned in the first summery of the original article.

As shown in the flow chart of FIG. 4, one embodiment is a method 200 of delivering additional content, such as fresh and/or engaging content, to a web site. Method 200 may include a step 210 of crawling, using a web crawler, a digital advertisement that for example appears on an advertiser's web site. In some embodiments, the advertisement of the advertiser(s) are fed to the web crawler without crawling the site.

Another step 220 may comprise monitoring user engagement of the advertisement. User engagement may be defined by any of the examples described with respect to system 10 or system 110. This step 220 may be performed repeatedly by a scripting language programming instruction, for example by executing scripting language programming instructions stored on a memory of a processing unit to repeatedly check to determine whether a user viewing a publisher's web site where the advertisement is displayed engages the advertisement by taking a predefined action.

Another step 230 may comprise requesting, for example using a programming interface, that a generative artificial intelligence program generate a summary of the advertisement.

Step 240 may involve executing scripting language programming instructions stored on a memory of a processing unit to, when the user engages the advertisement by the predefined action, display, by a browser, the summary of the advertisement in an advertising unit that includes the advertisement and that is displayed while the web site is being viewed by the user.

One version of method 200 also involves requesting the generating of the summary of the advertisement on demand after the user takes the predefined action. Another version of method 200 involves requesting that the generative artificial intelligence program generates the summary of the advertisement in advance of the user taking the predefined action and storing the summary on a memory storage.

Any of the details described with regard to systems 10 and 110 may be implemented in method 200 (and in methods 300 and 40 and 500). For example, the different predefined actions that define engagement by the use of an advertisement (or of a headline of an article) are equally application to any of the methods (200, 300, 400, 500) described herein.

For example, one version of method 200 may involve executing the scripting language programming instructions stored on the memory of the processing unit to repeatedly check whether the user viewing the web site screen moves a cursor or a body portion over the advertisement (the advertisement may be clickable to take the user to a different web site). Another version may involve executing the scripting language programming instructions stored on the memory of the processing unit to repeatedly check whether the user keeps the cursor or body portion over the advertisement for a predefined length of time. Another version may involve executing the scripting language programming instructions stored on the memory of the processing unit to repeatedly check whether the user scrolls to an area on the user's screen (i) that is a predefined distance from the advertisement or (ii) where the advertisement is viewable.

Similarly, method 200 may include executing the scripting language programming instructions to have the browser open a chat box on the user's screen, when the user engages the headline, to exchange messages with the user concerning the product or service promoted in the advertisement without the user having to leave the web site publishing the advertisement. Method 200 may also include requesting, using the programming interface, that the generative artificial intelligence program generate a response to a query concerning a product or services advertised in the advertisement and displaying the response to the query in the chatbox while the web site is being viewed by the user.

As seen in the flow chart of FIG. 5, another embodiment is a method 300 of delivering additional content, such as fresh and/or engaging content, to a web site.

Method 300 may include a step 310 of crawling the advertiser's advertisements on the publisher's web site and storing them.

Method 300 may include a further step 320 of requesting, for example by a programming software interface, a generative artificial intelligence program to generate a summary of an article and store the summary on a server of the web site. This is in contrast to method 200 where the summaries are generated on-demand.

Method 300 may also have a step 330 of executing scripting language programming instructions stored on the memory of a processing unit to monitor user engagement of the advertisements such as by repeatedly check to determine whether a user viewing a web site screen engages a headline (which may be clickable) by taking a predefined action (in any version as defined regarding systems 10, 110).

Another step 340 may involve, when the user engages the headline by the predefined action, displaying, for example by a browser, the summary of the headline in a content unit or a display unit for example on the client computer together with the content being viewed by the user while the web site is still viewed by the user. The way of causing the browser to display may be any version described with respect to systems 10, 110.

Some versions of method 300 involve executing the scripting language programming instructions to have the browser utilize a chatbot 170 in any of the manners or version described with respect to method 200.

In some cases, “enlisting an advertiser” is a preliminary business step for methods 200, 300 but this business step is not part of method 200 or method 300.

As shown in FIG. 6, method 400 of delivering additional content, such as fresh and/or engaging content, to a web site may include a step 410 of crawling the web for articles on a predefined topic (i.e. medicine, law or another field) and storing the articles, for example in a storage memory 15.

Another step 420 may comprise monitoring user engagement of a headline of an article, for example on a publisher's site.

Step 430 may comprise if the user engages the headline (as defined in any version described with respect to systems 10, 110), requesting a summary of the article (that is associated with the headline) from a generative AI program.

Method 400 may also comprise a step 440 of displaying the summary in a content unit on the web site viewed by the user such that the user need not leave the web site in order to see the summary.

As shown in FIG. 7, method 500 of delivering additional content, such as fresh and/or engaging content, to a web site may include a step 510 of crawling the web for articles on a predefined topic (i.e. medicine, law or another field) and storing the articles.

Another step 520 may comprise requesting and storing summaries of the articles from a generative AI program.

Step 530 may comprise monitoring user engagement of the headlines of the articles stored (the engagement as defined in any version described with respect to systems 10, 110).

Method 500 may also comprise a step 540 of, if the user engages with the headline, displaying the stored summary of the underlying article (associated with the headline) in a content unit on the web site viewed by the user such that the user need not leave the web site in order to see the summary.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more non-transitory computer readable (storage) medium(s) (for example memory 15, 115) having computer readable program code or programming instructions 14, 114 embodied thereon.

Any embodiments of systems 10, 110 or methods 200, 300, 400, 500 may include any hardware, such as a processing unit 12, 112 or such as one or more processors necessary to execute any of the programming instructions used in such system or method.

While the invention has been described with respect to a limited number of embodiments, it will be appreciated that many variations, modifications and other applications of the invention may be made. Therefore, the claimed invention, as recited in the claims that follow, is not limited to the embodiments described herein.

What is claimed is:

1. A system for delivering fresh and/or engaging content to a web site, comprising:
a memory storage;
a programming interface configured to send a request to a generative artificial intelligence program to generate a summary of an article either (i) on demand or (ii) in anticipation of a later request, and store the summary on a server of the web site;
scripting language programming instructions stored on the memory, that when executed by a processing unit perform:
(a) repeatedly checking whether a user viewing a web site screen engages a clickable headline of the article by taking a predefined action,
(b) when the user engages the headline by the predefined action, a browser displays the summary of the headline on the client computer while the web site is still viewed by the user.

2. The system of claim 1, further comprising a web crawler for crawling the web and searching for and indexing articles relating to a pre-identified topical area including the article.

3. The system of claim 1, wherein the headline, when clicked by the user, takes the user to a different publisher's web site.

4. The system of claim 1, wherein the predefined action comprises the user moving a cursor or a body portion over the headline.

5. The system of claim 4, wherein the predefined action comprises the user keeping the cursor or body portion over the headline for a predefined length of time.

6. The system of claim 1, wherein the predefined action comprises the user scrolling to an area on the user's screen (i) that is a predefined distance from the headline or (ii) where the headline is viewable.

7. The system of claim 1, wherein the scripting language programming instructions also, when executed, perform: the browser, when the user engages the headline, opening a chat box on a screen of the user to exchange messages with the user concerning the article underlying the headline without the user having to leave the web site publishing the headline.

8. The system of claim 1, wherein generative artificial intelligence programming instructions configured to, when executed by the processing unit, generate a second summary of content and store the second summary on the server of the web site; and
wherein the scripting language programming instructions also, when executed, perform
(a) repeatedly checking whether the user viewing the web site screen engages a clickable headline that is within the summary of the content by a second predefined action,
(b) when the user engages the clickable or advertisement that is within the summary by the second predefined action, manipulating and populating HTML such that the browser displays the text and any images of the second summary on the client computer while the web site is still viewed by the user.

9. The system of claim 1, wherein the browser displays the summary within a display unit that includes the headline.

10. A system for delivering fresh and/or engaging content to a web site, comprising:
a programming interface that requests from a generative artificial intelligence program to generate a summary of an advertisement or an answer to a query about the advertisement either (i) on demand or (ii) in anticipation of a later request, and store the summary or answer on a server of the web site;
scripting language programming instructions stored on a memory, that when executed by a processing unit perform:
(a) repeatedly checking to determine whether a user viewing a web site screen engages the advertisement by taking a predefined action,
(b) when the user engages the advertisement by the predefined action, displaying, by a browser, the summary of the advertisement or the answer to the query about the advertisement on the user's device while the web site is still viewed by the user.

11. The system of claim 10, further comprising a web crawler for crawling advertisements on one or more web sites to catalog/index information gleaned from the advertisement.

12. The system of claim 10, wherein the advertisement when clicked takes the user to a different publisher's web site.

13. The system of claim 10, wherein the scripting language programming instructions also, when executed, perform: prior to displaying the summary upon engagement by the user of the advertisement, either retrieving the summary from memory or requesting, by the programming interface, of the generative artificial intelligence program to generate the summary.

14. The system of claim 10, wherein the predefined action is the user moving a cursor or a body portion over the advertisement.

15. The system of claim 14, wherein the predefined action comprises the user maintaining the cursor or body portion over the advertisement for a predefined length of time.

16. The system of claim 10, wherein the predefined action comprises the user scrolling to an area on the user's screen (i) that is a predefined distance from the advertisement or (ii) where the advertisement is viewable.

17. The system of claim 10, wherein the scripting language programming instructions also, when executed, perform: the browser, when the user engages the advertisement, opening a chat box on a screen of the user to exchange messages with the user concerning the product or service advertised in the advertisement without the user having to leave the web site publishing the advertisement.

18. The system of claim 10, wherein the scripting language programming instructions is configured to have the browser open a chat box on the user's screen, when the user engages the advertisement, and wherein the programming interface is configured to request that the generative artificial intelligence program generate a response to a query of the user concerning a product or services advertised in the advertisement, the response displayed in the chatbox while the web site is being viewed by the user.

19. A method of delivering fresh and/or engaging content to a web site, comprising:
crawling, using a web crawler, a digital advertisement on an advertiser's web site;
requesting, using a programming interface, that a generative artificial intelligence program generates a summary of the advertisement; and
executing scripting language programming instructions stored on a memory of a processing unit to:
(a) repeatedly check to determine whether a user viewing a publisher's web site where the advertisement is displayed engages the advertisement by taking a predefined action, wherein the advertisement is clickable so as to leave the publisher's web site,
(b) when the user engages the advertisement by the predefined action, display, by a browser, the summary of the advertisement in an advertising unit that includes the advertisement and that is displayed while the web site is being viewed by the user.

20. The method of claim 19, further comprising requesting the generating of the summary of the advertisement on demand after the user takes the predefined action.

21. The method of claim 19, further comprising requesting that the generative artificial intelligence program generates the summary of the advertisement in advance of the user taking the predefined action and storing the summary on a memory storage.

22. The method of claim 19, further comprising executing the scripting language programming instructions stored on the memory of the processing unit to repeatedly check whether the user viewing the web site screen moves a cursor or a body portion over the advertisement.

23. The method of claim 22, further comprising executing the scripting language programming instructions stored on the memory of the processing unit to repeatedly check whether the user keeps the cursor or body portion over the advertisement for a predefined length of time.

24. The method of claim 19, further comprising executing the scripting language programming instructions stored on the memory of the processing unit to repeatedly check whether the user scrolls to an area on the user's screen (i) that is a predefined distance from the advertisement or (ii) where the advertisement is viewable.

25. The method of claim 19, further comprising executing the scripting language programming instructions to have the browser open a chat box on the user's screen, when the user engages the headline, to exchange messages with the user concerning the product or service promoted in the advertisement without the user having to leave the web site publishing the advertisement.

26. The method of claim 19, further comprising requesting, using the programming interface, that the generative artificial intelligence program generate a response to a query concerning a product or services advertised in the advertisement and displaying the response to the query in the chatbox while the web site is being viewed by the user.

27. A method of delivering fresh and/or engaging content to a web site, comprising:
requesting, by a programming software interface, a generative artificial intelligence program to generate a summary of an article and store the summary on a server of the web site;
executing scripting language programming instructions stored on the memory of a processing unit to:
(a) repeatedly check to determine whether a user viewing a web site screen engages a clickable headline by taking a predefined action,
(b) when the user engages the headline by the predefined action, display, by a browser, the summary of the headline on the client computer while the web site is still viewed by the user.

28. The method of claim 27, further comprising using a web crawler to search for and index articles relating to a pre-identified topical area, wherein the article is one of the articles found in the search by the web crawler.

29. The method of claim 27, further comprising executing the scripting language programming instructions stored on the memory of the processing unit to repeatedly check whether the user viewing the web site screen moves a cursor or a body portion over the headline.

30. The method of claim 29, further comprising executing the scripting language programming instructions stored on the memory of the processing unit to repeatedly check whether the user keeps the cursor or body portion over the headline for a predefined length of time.

31. The method of claim 27, further comprising executing the scripting language programming instructions stored on the memory of the processing unit to repeatedly check whether the user scrolls to an area on the user's screen (i) that is a predefined distance from the headline or (ii) where the headline is viewable.

32. The method of claim 27, further comprising executing the scripting language programming instructions to have the browser open a chat box on the user's screen, when the user engages the headline, to exchange messages with the user concerning the article underlying the headline without the user having to leave the web site publishing the headline.

33. The method of claim 27, further comprising requesting the generating of the summary of the article on demand after the user takes the predefined action.

34. The method of claim 27, further comprising requesting that the generative artificial intelligence program generates the summary of the advertisement in advance of the user taking the predefined action and storing the summary on a memory storage.

35. The method of claim 27, further comprising executing generative artificial intelligence programming instructions to generate a second summary of content and to store the second summary on the server of the web site; and
executing the scripting language programming instructions to:
(a) repeatedly check to determine whether the user viewing the web site screen engages a clickable headline that is within the summary of the content by taking a second predefined action, and
(b) when the user engages the clickable headline that is within the summary by the second predefined action, the browser displays the text and any images of the second summary on the client computer while the web site is still viewed by the user.
